(19) United States
(12) Patent Application Publication
(10) Pub. No.: US 2025/0004293 A1
(43) Pub. Date: Jan. 2, 2025

(54) VIBRATION REDUCING SYSTEM FOR VEHICULAR REARVIEW MIRROR ASSEMBLY

(71) Applicant: Magna Mirrors of America, Inc., Holland, MI (US)

(72) Inventor: John T. Uken, Jenison, MI (US)

(21) Appl. No.: 18/754,530

(22) Filed: Jun. 26, 2024

Related U.S. Application Data
(60) Provisional application No. 63/510,932, filed on Jun. 29, 2023.

(51) Int. Cl. G02B 27/64; B60R 1/04; B60R 1/06; B60R 1/12

(52) U.S. Cl. CPC G02B 27/646; B60R 1/04; B60R 1/06; B60R 1/12; B60R 2001/1223

(57) ABSTRACT

A vehicular rearview mirror assembly includes a mirror head that includes a mirror reflective element. The mirror head accommodates a vibration sensor operable to determine vibration of the mirror reflective element. The mirror head accommodates a vibration actuator that is electrically operable to vibrate at least the mirror reflective element. Based on the determined vibration of the mirror reflective element, the vibration actuator is electrically operated to vibrate at least the mirror reflective element to at least partially counter vibration of the mirror reflective element.

### CROSS REFERENCE TO RELATED APPLICATION

The present application claims the filing benefits of U.S. provisional application Ser. No. 63/510,932, filed Jun. 29, 2023, which is hereby incorporated herein by reference in its entirety.

### FIELD OF THE INVENTION

The present invention relates generally to the field of rearview mirror assemblies for vehicles, such as interior and exterior rearview mirror assemblies.

### BACKGROUND OF THE INVENTION

It is known to provide a mirror assembly that is adjustably mounted to an interior portion of a vehicle, or that is mounted at an exterior portion of a vehicle. The mirror assembly includes a mirror reflective element, such as an electrochromic mirror reflective element having a front glass substrate and a rear glass substrate with an electrochromic medium sandwiched between the glass substrates, or such as a single glass substrate having a mirror reflector coating disposed thereat.

### SUMMARY OF THE INVENTION

The present invention provides a vehicular rearview mirror assembly (such as an exterior mirror assembly mounted at a side of an equipped vehicle or an interior mirror assembly mounted at an interior portion of the equipped vehicle) equipped with a vibration reduction system for reducing vibration at the mirror assembly and thus improving the view provided to the driver of the vehicle, reducing noise as the vehicle travels along the road and providing opportunities for weight and cost savings.

For example, the mirror assembly, such as an exterior rearview mirror assembly or an interior rearview mirror assembly, includes a mirror head adjustable relative to a mounting base or structure. The mounting base is configured to attach at the vehicle. The mirror head includes a mirror reflective element. The mirror head accommodates a vibration monitoring sensor that determines vibratory movement of the mirror reflective element and/or the mirror head relative to the vibration monitoring sensor (e.g., a vibration frequency and amplitude of the mirror reflective element). The mirror head accommodates a vibration actuator. The vibration actuator is electrically operable to impart movement, such as vibration, of the mirror reflective element and/or mirror head. Responsive to the vibration monitoring sensor determining vibratory movement of the mirror reflective element, the vibration actuator is electrically operated to impart vibration of at least the mirror reflective element that at least partially mitigates or counters the detected movement of the mirror reflective element. For example, the vibration actuator may impart vibration of the mirror reflective element and/or mirror head that reduces or cancels out the detected vibration.

These and other objects, advantages, purposes and features of the present invention will become apparent upon review of the following specification in conjunction with the drawings.

### BRIEF DESCRIPTION OF THE DRAWINGS

FIG. 1 is a view of an exterior rearview mirror assembly attached at a side of a vehicle;

FIG. 2 is a plan view of the rear side of an attachment plate attached at the mirror reflective element of the exterior rearview mirror assembly;

FIG. 3 is a plan view of the front side of the mirror reflective element of the exterior rearview mirror assembly;

FIGS. 4 and 5 are views of an interior rearview mirror assembly; and

FIGS. 6 and 7 are diagrams showing detected vibrations at the mirror assembly and vibration imparted at the mirror assembly by the actuator of the vibration reduction system.

### DESCRIPTION OF THE PREFERRED EMBODIMENTS

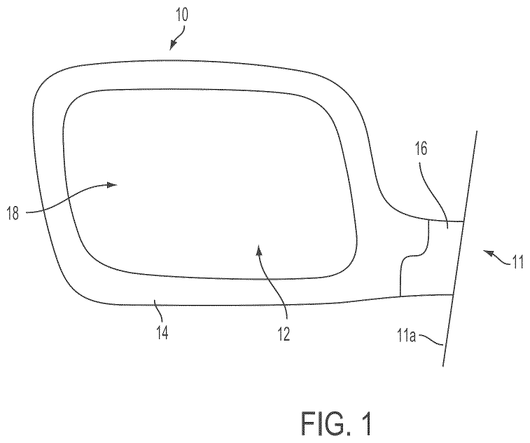

Referring now to the drawings and the illustrative embodiments depicted therein, an exterior rearview mirror assembly 10 for a vehicle 11 includes a mirror reflective element 12 received in and/or supported at or by a mirror head portion 14 (FIG. 1). The mirror head portion 14 may be fixedly attached at a mounting arm or base 16 at the side of the vehicle or may be movably mounted to a mounting arm or base or portion 16, and may comprise a breakaway mirror (where the mirror head portion may be manually pivoted about the mounting arm or base) or may comprise a powerfold mirror (where the mirror head portion may be pivoted via an actuator assembly or adjustment device). The mounting arm or base 16 of the mirror assembly 10 is mounted at the side 11a of a host or subject vehicle 11, with the reflective element 12 providing a rearward field of view along the respective side of the vehicle to the driver of the vehicle. As discussed further below, the mirror assembly 10 includes a vibration reduction system configured to detect and counteract vibration and movement of the mirror head and/or mirror reflective element relative to the vehicle.

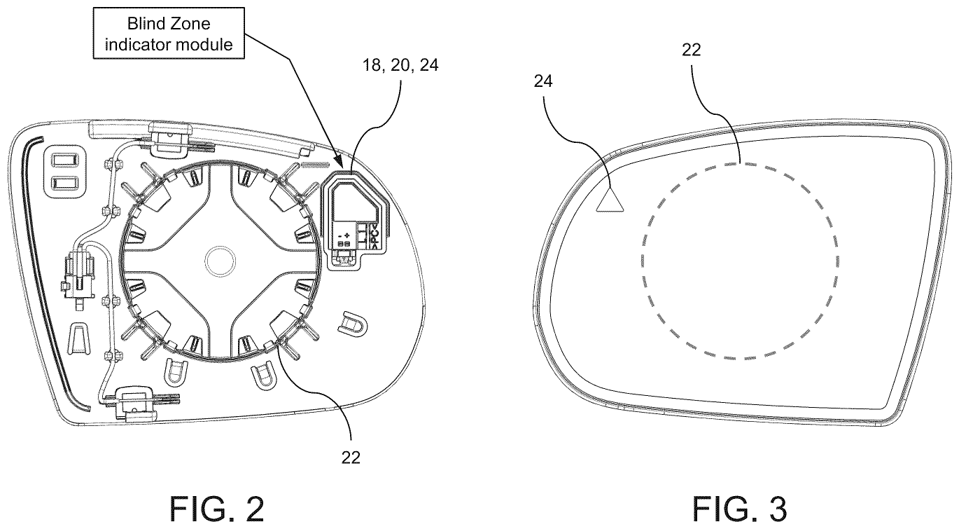

Referring to FIGS. 1-3, 6 and 7, the exterior rearview mirror assembly 10 includes a vibration monitoring sensor 18, such as an accelerometer, that is configured to detect acceleration or movement or vibration of the mirror reflective element 12 relative to the mirror head 14 and/or the vehicle 11. An electronic control unit (ECU), which may be disposed at the mirror assembly 10 or include a central ECU at the vehicle, includes a data processor for processing sensor data captured by the sensor 18. Based on processing of the captured sensor data, the system detects the vibration of the mirror reflective element 12 and controls operation of an actuator 20, such as a haptic actuator, piezoelectric actuator (PA), linear resonant actuator (LRA), voice coil actuator (VCA), voice coil motor (VCM) and the like, at the mirror assembly 10 to impart movement of the mirror reflective element 12 that reduces or cancels the detected vibration. The actuator 20 may include or be coupled to a mass at the mirror reflective element 12 for imparting movement of the mirror reflective element 12. In other words, and as discussed further below, based on vibratory movement of the mirror reflective element 12 detected at the sensor 18, the system operates the actuator 20 to impart a mitigating vibration of the mirror reflective element 12.

The actuator 20 may be configured to impart movement or vibration of the mirror reflective element 12 in a primary vibration direction. For example, with the mirror assembly 10 attached at the side of the vehicle and as the vehicle travels along the road, the mirror reflective element 12 may primarily vibrate along a vertical axis relative to a plane of the mirror reflective element 12 based on forces transferred through the vehicle to the mirror reflective element 12. Accordingly, the actuator 20 is operable to impart movement of the mirror reflective element 12 along the vertical axis, such as equal and opposite movement as the detected vibration of the mirror reflective element 12. Thus, the sensor 18 may be configured to primarily or only detect movement of the mirror reflective element 12 along the vertical axis. Put another way, the vibration reduction system may be focused on one axis of vibration, such as an axis of vibration along which the mirror head and/or mirror reflective element has its lowest resonance frequency (i.e., the first mode). Thus, the actuator may be used to reduce the amplitude of vibration or shift the resonance point.

Optionally, the sensor 18 may be configured to detect movement of the mirror reflective element 12 along a plurality of movement axes, such as the vertical axis and a horizontal axis relative to the plane of the mirror reflective element and the actuator 20 may be configured to impart movement of the mirror reflective element 12 along the plurality of axes. Optionally, the system may include a plurality of sensors and actuators configured to detect movement and impart movement along respective axes. The system may determine a frequency and amplitude of a vibration of the mirror reflective element and/or mirror head and may generate a vibration at that frequency and amplitude, but with a 180 degree phase shift so that the generated vibration mitigates or at least partially cancels or offsets the determined vibration.

The exterior rearview mirror assembly 10 may comprise a powerfold mirror assembly that includes a powerfold actuator 22. The powerfold actuator 22 is operable to pivot the mirror head (including the mirror casing and the mirror reflective element) relative to the mounting arm or base. The powerfold actuator 22 may be electrically operable in response to a user input and may pivot the mirror head between at least a folded or park position, where the mirror head is pivoted in toward the side of the vehicle so that the mirror reflective element 12 faces the side of the vehicle, and an extended or drive or use position, where the mirror head is pivoted out from the park position so that the mirror reflective element 12 provides the field of view to the driver rearward and along the side of the vehicle. Optionally, the mirror head may be manually pivotable to a forward fold position, where the mirror head is pivoted beyond the drive position, such as upon impact with an object.

With the mirror head in the extended position, the mirror reflective element 12 may be adjustable relative to the mirror head 14 to adjust the field of view provided by the mirror reflective element 12 to the driver of the vehicle rearward and along the side of the vehicle. Thus, when the mirror head is in the extended position, the mirror head is pivoted to a fixed or repeatable position via the powerfold actuator 22, and the mirror reflective element 12 may be separably adjustable relative to the mirror head 14. Optionally, the mirror reflective element 12 may be fixed relative to the mirror head 14 and thus, to adjust the field of view provided by the mirror reflective element 12 to the driver of the vehicle, the 55741800.1 4 powerfold actuator 22 is further operated to adjust the entire mirror head to adjust the position of the mirror reflective element 12 relative to the driver. Thus, when the mirror head is pivoted to the extended position, the mirror head is further pivotable at the extended position (such as to a lesser degree) to adjust the field of view. For example, the exterior rearview mirror assembly may include characteristics of the mirror assemblies described in U.S. Pat. Nos. 11,396,264; 10,099,618; 9,827,913; 9,487,142; 9,346,403; 9,067,541 and/or 7,887,202, and/or U.S. Publication Nos. US-2023-0009664; US-2022-0126751; US-2021-0261053; US-2020-0353867 and/or US-2020-0223364, which are all hereby incorporated herein by reference in their entireties.

The vibration monitoring sensor 18 and the actuator 20 may be integrated with or disposed at the powerfold actuator 22. For example, the vibration monitoring sensor 18 may measure vibration or movement of the mirror reflective element 12 relative to a mounting bracket or attachment plate of the mirror reflective element 12 at the powerfold actuator 22. Further, the system may control operation of the powerfold actuator 22 to reduce or cancel vibration measured at the mirror reflective element 12. Put another way, when the powerfold actuator 22 is not being operated to adjust the position of the mirror reflective element and/or the mirror head relative to the side of the vehicle for adjusting the field of view of the driver, the powerfold actuator may impart vibratory movement of the mirror reflective element 12 and/or the mirror head 14 to reduce or eliminate the vibration detected at the mirror reflective element 12.

When the mirror reflective element 12 is adjustable relative to the mirror head 14, the actuator applies vibration directly to the mirror reflective element to mitigate the detected vibration. When the mirror reflective element 12 is fixed relative to the mirror head 14, the actuator may apply vibration to the mirror head to mitigate the detected vibration.

Moreover, the mirror head 14 may accommodate a blind zone indicator (BZI) module 24 at or behind the mirror reflective element 12 and configured to provide an alert to the driver of the vehicle when another vehicle or object is present in a blind zone of the vehicle along the side of the vehicle. The vibration monitoring sensor 18 and/or the actuator 20 may be integrated with or disposed at the BZI module 24.

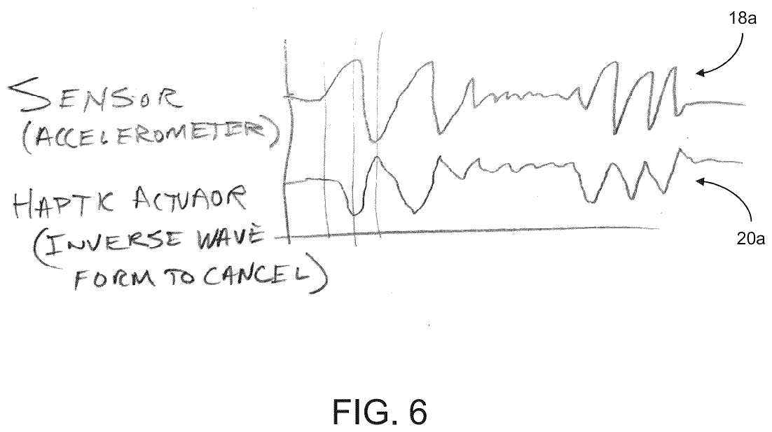

In other words, the vibration reduction system includes the sensor 18 to detect glass acceleration or movement (e.g., frequency and amplitude of vibration) and utilizes the haptic actuator or piezo actuator 20 or similar device, which may include an integrated mass, to reduce or cancel the detected movement (such as via generating a similar frequency and amplitude vibration with a 180 degree phase shift). The microprocessor at the ECU may analyze sensor inputs 18a representative of the detected vibration and generate an inverse signal 20a for the actuator 20 (FIG. 6).

In some examples, the actuator 20 may generate vibrations corresponding to inverse or phase shifted signals of the detected peak frequencies so as to reduce or cancel at least the peak frequencies. In other words, the inverse signal 20a may be generated based on the peak frequencies (i.e., those detected frequencies having the greatest amplitude) rather than a continuous signal or waveform.

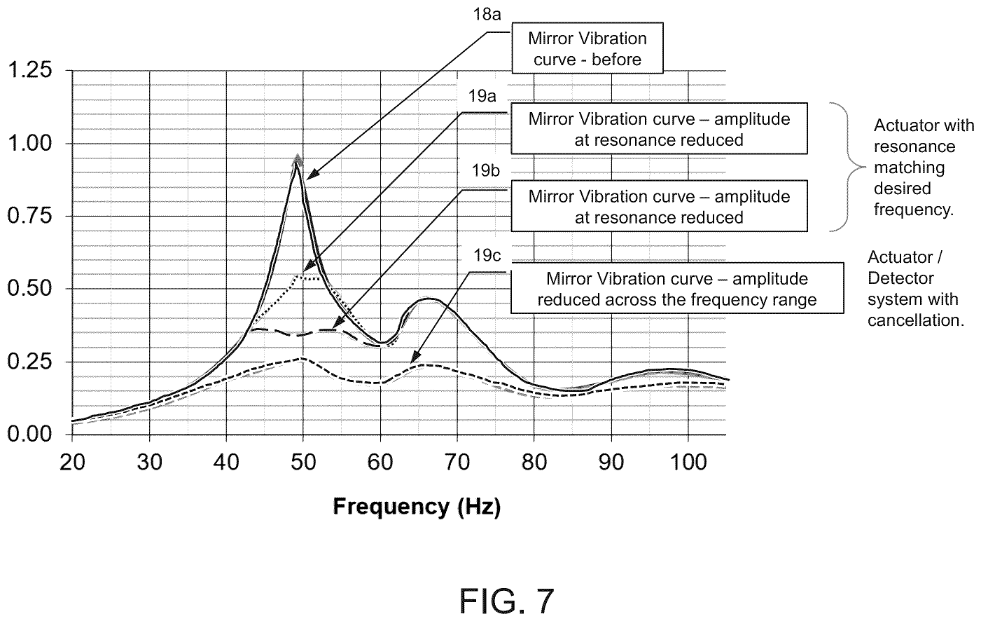

As shown in FIG. 7, line 18a represents the detected vibration amplitudes of the mirror reflective element or mirror head when no corrective vibration is applied and lines 19a, 19b, and 19c represent vibration amplitudes of the mirror reflective element when various corrective or vibration-countering vibrations are applied. As shown by line 18a, the mirror reflective element or mirror head may have a resonant frequency of about 50 Hz. Lines 19a and 19b represent vibration amplitudes of the mirror reflective element or mirror head when corrective vibration is applied at or near the resonant frequency. This reduces the vibration amplitude at the resonant frequency. That is, the resonance of the actuator may match the resonance of the mirror reflective element or mirror head, or any desired frequency, to reduce the vibration amplitude of the mirror reflective element or mirror head when the actuator is operated. Line 19c represents vibration amplitudes of the mirror reflective element or mirror head when corrective vibration is applied across the detected frequency range, such as at the inverse signal 20a (FIG. 6), to at least partially reduce or cancel the vibration of the mirror reflective element or mirror head.

The sensor 18 and/or the actuator 20 may be added to the BZI module 24 along with the microprocessor or ECU. Optionally, the sensor 18 and/or the actuator 20 may be a separate device at the mirror assembly 10 and it may be beneficial to separate the sensor 18 and the actuator 20.

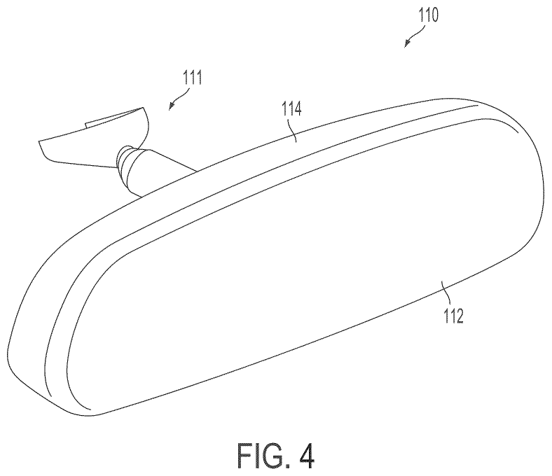

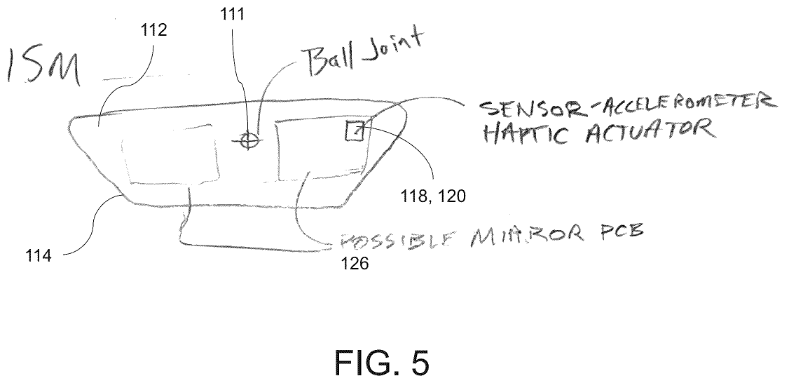

Referring to FIGS. 4-7, an interior rearview mirror assembly 110 may include the vibration reduction system. For example, the interior rearview mirror assembly 110 includes a mirror head that includes a mirror casing 114 and a mirror reflective element 112 positioned at a front portion of the casing 114 (FIG. 4). In the illustrated embodiment, the mirror assembly 110 is configured to be adjustably mounted to an interior portion of a vehicle (such as to an interior or in-cabin surface of a vehicle windshield or a headliner of a vehicle or the like) via a mounting structure or mounting configuration or assembly 111. The mirror reflective element 112 comprises a variable reflectance mirror reflective element that varies its reflectance responsive to electrical current applied to conductive coatings or layers of the reflective element.

A printed circuit board (PCB) 126 at the mirror assembly 110 may accommodate the one or more processors of the ECU and the PCB 126 may accommodate the vibration monitoring sensor 118 and/or the actuator 120 that imparts vibratory movement of the mirror reflective element 112. The PCB 126 may be attached at the mirror reflective element 112, such as to a backing plate that attaches the mirror reflective element 112 at the mirror casing 114, for measuring or detecting vibration or movement of the mirror reflective element via the accelerometer 118 and for imparting vibratory movement of the mirror reflective element 112 or mirror head via the haptic actuator 120. Thus, the sensor 118 and/or the actuator 120 may be added to the electrochromic PCB or another existing PCB within the mirror head, or the vibration reduction system PCB could be completely independent.

The sensor 118 and the actuator 120 may be positioned strategically at the interior rearview mirror assembly 110 to cancel out vibration along a primary vibration direction or axis (e.g., a vertical vibration axis relative to the plane of the mirror reflective element). Optionally, if multiple directions are needed, a multi-axis actuator and/or sensor or multiple sensors and actuators responsible for different respective axes of movement, may be used. Optionally, the sensor 118 and/or the actuator 120 are coupled to the ball joint of the mounting structure 111 for measuring movement of the mirror head relative to the mounting structure 111 and imparting movement of the mirror head relative to the mounting structure 111.

The vibration reduction system detects vibratory movement or vibration of the mirror reflective element relative to the mirror head and/or the vehicle. For example, when the mirror reflective element is fixed relative to the mirror head, the vibration monitoring sensor detects vibration of the mirror head relative to the vehicle (e.g., relative to the mounting structure attached to the vehicle). When the mirror reflective element is adjustable relative to the mirror head, the vibration monitoring sensor detects vibration of the mirror reflective element relative to the mirror head. Based on the detected vibration, the vibration actuator is operated to impart a mitigating vibration of the mirror reflective element and/or mirror head. Optionally, when the mirror reflective element is adjustable relative to the mirror head, the vibration monitoring sensor may also detect vibration of the mirror head relative to the vehicle, such that the vibration actuator may operate to impart a mitigating vibration of the mirror reflective element and/or mirror head relative to the vehicle. In some examples, the system may determine a pattern or frequency and amplitude of the detected vibration at the mirror reflective element to impart a vibration of substantially equal and opposite frequency at an amplitude configured to reduce or eliminate the detected vibration (FIG. 6). Optionally, the actuator may be operated to impart vibration of the mirror reflective element based on an average or median frequency and/or amplitude of the detected vibration. Further, the actuator may be operated to impart vibration of the mirror reflective element at or near a resonant frequency of the mirror reflective element to at least reduce the amplitude of the vibration of the mirror reflective element at or near the resonant frequency of the mirror reflective element (FIG. 7).

Optionally, the vibration reduction system may operate as a self-correcting system. For example, based on detecting vibration of the mirror reflective element above a threshold frequency and/or amplitude, the system may operate the vibration actuator to impart the mitigating vibration. Because the system operates the vibration actuator to reduce or eliminate vibration of the mirror reflective element, the system may adjust operation of the actuator so that the detected vibration of the mirror reflective element is below the threshold frequency and/or amplitude. If the detected vibration increases above the threshold frequency and/or amplitude, the system may again adjust operation of the actuator so that the detected vibration is below the threshold.

Thus, the vibration reduction system is configured to reduce or eliminate or cancel movement and vibration of the mirror reflective element and/or mirror head relative to mounting structure as the vehicle travels along the road. This may improve the ability of the driver to view the rearward field of view provided by the mirror assembly, reduce noise caused by vibration of the mirror assembly and improve the lifespan of the mirror assembly.

Optionally, the vibration reduction system may be integrated with a camera or sensor system of the vehicle to stabilize a camera or sensor relative to the vehicle and/or stabilize sensor data captured by the camera or sensor. For example, a camera wing may be disposed at a side of a vehicle and extend at least partially from the side of the vehicle so that a camera accommodated at the camera wing views at least rearward and along the side of the vehicle at which the wing is disposed. In some examples, the camera is accommodated at the exterior rearview mirror assembly. Image data captured by the camera may be processed to generate video images for the driver of the vehicle that are representative of the rearward view along the side of the vehicle. Vibration of the camera wing and/or camera accommodated by the wing may cause distortion or shaking or otherwise reduce the quality of the video images. Thus, the vibration reduction system may include a vibration monitoring sensor configured to detect vibration of the camera wing and/or camera and an actuator operable to impart vibration of the camera wing and/or camera to at least partially mitigate the detected vibration. Reducing or eliminating the vibration of the camera wing and/or camera may improve the quality of the video images. In some examples, the vibration reduction system may detect the vibration of the camera wing and/or camera and the image data may be processed based on the detected vibration to reduce or eliminate vibration in the displayed video images. That is, the vibration reduction may be performed mechanically and/or in software.

Further, the interior mirror assembly may accommodate a camera or sensor of a driver monitoring system (DMS) of the vehicle and the vibration reduction system may be operable to detect and reduce or eliminate vibrations of the DMS camera and/or interior mirror head for improving the quality of image data captured by the DMS camera. Based on the detected vibration of the DMS camera and/or mirror head, the vibration reduction system may impart the mitigating vibration of the DMS camera and/or mirror head, or the image data captured by the camera may be processed based on the detected vibrations.

The vibration reduction system may be configured to reduce any vibration frequency, such as a vibration frequency of 20 Hertz or more, 80 Hertz or more, 200 Hertz or more and the like. For example, the system may prioritize vibration reduction between 20 Hertz and 80 Hertz. The vibration reduction system may reduce the need for heavy structures or expensive vibration reduction materials to achieve vibration performance. Additional cost of the vibration reduction system may be offset or at least partially offset by use of lower cost materials and components, and providing weight savings benefits.

The exterior rearview mirror assembly may utilize aspects of the mirror assemblies described in U.S. Publication Nos. US-2021-0331625; US-2021-0316664; U.S. 2021-0213880; US-2020-0353867 and/or US-2020-0223364, and/or U.S. Pat. Nos. 11,325,535; 10,099,618; 9,827,913; 9,487,142; 9,346,403 and/or 8,915,601, which are all hereby incorporated herein by reference in their entireties.

Optionally, the exterior rearview mirror assembly may include a blind spot indicator and/or a turn signal indicator, such as an indicator or indicators of the types described in U.S. Pat. Nos. 8,242,896; 7,492,281; 6,198,409; 5,929,786; and 5,786,772, which are hereby incorporated herein by reference in their entireties. The signal indicator or indication module may include or utilize aspects of various light modules or systems or devices, such as the types described in U.S. Pat. Nos. 8,764,256; 7,626,749; 7,581,859; 6,227,689; 6,582,109; 5,371,659; 5,497,306; 5,669,699; 5,823,654; 6,176,602 and/or 6,276,821, and/or U.S. Publication No. US-2013-0242586, which are all hereby incorporated herein by reference in their entireties.

The exterior rearview mirror assembly or the interior rearview mirror assembly may comprise an electro-optic or electrochromic mirror assembly that includes an electro-optic or electrochromic reflective element. The perimeter edges of the reflective element may be encased or encompassed by the perimeter element or portion of the bezel portion to conceal and contain and envelop the perimeter edges of the substrates and the perimeter seal disposed therebetween. The electrochromic mirror element of the electrochromic exterior rearview mirror assembly may utilize the principles disclosed in commonly assigned U.S. Pat. Nos. 8,503,061; 7,274,501; 7,255,451; 7,195,381; 7,184,190; 6,690,268; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407 and/or 4,712,879, which are hereby incorporated herein by reference in their entireties.

Optionally, the exterior rearview mirror assembly may include a non-electro-optic mirror assembly (such as a generally planar or optionally slightly curved mirror substrate) or an electro-optic or electrochromic mirror assembly. Optionally, the exterior rearview mirror assembly may comprise a mirror assembly of the types described in U.S. Pat. Nos. 7,420,756; 7,289,037; 7,274,501; 7,338,177; 7,255,451; 7,249,860; 6,318,870; 6,598,980; 5,327,288; 4,948,242; 4,826,289; 4,436,371 and 4,435,042, which are hereby incorporated herein by reference in their entireties. A variety of mirror accessories and constructions are known in the art, such as those disclosed in U.S. Pat. Nos. 5,555,136; 5,582,383; 5,680,263; 5,984,482; 6,227,675; 6,229,319 and 6,315,421 (which are hereby incorporated herein by reference in their entireties), that can benefit from the present invention.

The interior rearview mirror assembly may comprise any suitable construction, such as, for example, a mirror assembly with the reflective element being nested in the mirror casing and with a bezel portion that circumscribes a perimeter region of the front surface of the reflective element, or with the mirror casing having a curved or beveled outermost exposed perimeter edge around the reflective element and with no overlap onto the front surface of the reflective element (such as by utilizing aspects of the mirror assemblies described in U.S. Pat. Nos. 7,184, 190; 7,274,501; 7,255,451; 7,289,037; 7,360,932; 7,626,749; 8,049,640; 8,277,059 and/or 8,529,108, which are hereby incorporated herein by reference in their entireties) or such as a mirror assembly having a rear substrate of an electro-optic or electrochromic reflective element nested in the mirror casing, and with the front substrate having a curved or beveled outermost exposed perimeter edge, or such as a mirror assembly having a prismatic reflective element that is disposed at an outer perimeter edge of the mirror casing and with the prismatic substrate having a curved or beveled outermost exposed perimeter edge, such as described in U.S. Pat. Nos. 9,827,913; 9,174,578; 8,508,831; 8,730,553; 9,598,016 and/or 9,346,403, and/or U.S. Des. Pat. Nos. D633,423; D633,019; D638,761 and/or D647,017, which are hereby incorporated herein by reference in their entireties (and with electrochromic and prismatic mirrors of such construction are commercially available from the assignee of this application under the trade name INFINITY™ mirror).

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,582,425; 11,518,401; 10,958,830; 10,065,574; 10,017,114; 9,405,120 and/or 7,914,187, and/or U.S. Publication Nos. US-2022-0377219; US-2022-0254132; US-2022-0242438; US-2021-0323473; US-2021-0291739; US-2020-0320320; US-2020-0202151; US-2020-0143560; US-2019-0210615; US-2018-0231976; US-2018-0222414; US-2017-0274906; US-2017-0217367; US-2016-0209647; US-2016-0137126; US-2015-0352953; US-2015-0296135; US-2015-0294169; US-2015-0232030; US-2015-0092042; US-2015-0022664; US-2015-0015710; US-2015-0009010 and/or US-2014-0336876, and/or U.S. patent application Ser. No. 18/666,959, filed May 17, 2024 (Attorney Docket DON01 P5121), and/or U.S. patent application Ser. No. 18/535,183, filed Dec. 11, 2023 (Attorney Docket MAG04 P5021), and/or U.S. patent application Ser. No. 18/508,351, filed Nov. 14, 2023 (Attorney Docket DON01 P4996), and/or U.S. provisional application Ser. No. 63/641,574, filed May 2, 2024 (Attorney Docket DON01 P5156), and/or International Publication Nos. WO 2023/220222; WO 2022/241423; WO 2022/187805 and/or WO 2023/034956, which are all hereby incorporated herein by reference in their entireties.

Optionally, the driver monitoring system may be integrated with a camera monitoring system (CMS) of the vehicle. The integrated vehicle system incorporates multiple inputs, such as from the inward viewing or driver monitoring camera and from the forward-viewing camera, as well as from a rearward-viewing camera and sideward-viewing cameras of the CMS (e.g., a rearward-viewing camera disposed at the rear of the vehicle remote from the rear backup camera of the vehicle, and rearward-viewing cameras disposed at respective sides of the vehicle, such as at respective side-mounted exterior rearview mirror assemblies of the vehicle), to provide the driver with unique collision mitigation capabilities based on full vehicle environment and driver awareness state. The rearward viewing camera may comprise a rear backup camera of the vehicle or may comprise a centrally located higher mounted camera (such as at a center high-mounted stop lamp (CHMSL) of the vehicle), whereby the rearward viewing camera may view rearward and downward toward the ground at and rearward of the vehicle. The image processing and detections and determinations are performed locally within the interior rearview mirror assembly and/or the overhead console region, depending on available space and electrical connections for the particular vehicle application. The CMS cameras and system may utilize aspects of the systems described in U.S. Publication Nos. US-2021-0245662; US-2021-0162926; US-2021-0155167; US-2018-0134217 and/or US-2014-0285666, and/or International Publication No. WO 2022/150826, which are all hereby incorporated herein by reference in their entireties.

The ECU may receive image data captured by a plurality of cameras of the vehicle, such as by a plurality of surround view system (SVS) cameras and a plurality of camera monitoring system (CMS) cameras and optionally one or more driver monitoring system (DMS) cameras. The ECU may comprise a central or single ECU that processes image data captured by the cameras for a plurality of driving assist functions and may provide display of different video images to a video display screen in the vehicle (such as at an interior rearview mirror assembly or at a central console or the like) for viewing by a driver of the vehicle. The system may utilize aspects of the systems described in U.S. Pat. No. 10,442,360 and/or 10,046,706, and/or U.S. Publication Nos. US-2021-0245662; US-2021-0162926; US-2021-0155167 and/or US-2019-0118717, and/or International Publication No. WO 2022/150826, which are all hereby incorporated herein by reference in their entireties.

Changes and modifications in the specifically described embodiments may be carried out without departing from the principles of the present invention, which is intended to be limited only by the scope of the appended claims as interpreted according to the principles of patent law.

1. A vehicular rearview mirror assembly, the vehicular rearview mirror assembly comprising:
a mirror head adjustable about a mounting structure, wherein the mounting structure is configured to mount the vehicular rearview mirror assembly at a vehicle;
wherein the mirror head comprises a mirror reflective element;
wherein the mirror head accommodates a vibration sensor, and wherein, with the vehicular rearview mirror assembly mounted at the vehicle, the vibration sensor is operable to determine vibration of the mirror reflective element;
wherein the mirror head accommodates a vibration actuator, and wherein the vibration actuator is electrically operable to vibrate at least the mirror reflective element; and
wherein, with the vehicular rearview mirror assembly mounted at the vehicle, and based on the determined vibration of the mirror reflective element, the vibration actuator is electrically operated to vibrate at least the mirror reflective element to at least partially counter vibration of the mirror reflective element.

2. The vehicular rearview mirror assembly of claim 1, wherein the vehicular rearview mirror assembly comprises a vehicular interior rearview mirror assembly.

3. The vehicular rearview mirror assembly of claim 1, wherein the vehicular rearview mirror assembly comprises a vehicular exterior rearview mirror assembly.

4. The vehicular rearview mirror assembly of claim 1, wherein the vibration sensor comprises an accelerometer.

5. The vehicular rearview mirror assembly of claim 1, wherein the vibration actuator comprises one selected from the group consisting of (i) a haptic actuator and (ii) a piezoelectric actuator.

6. The vehicular rearview mirror assembly of claim 1, wherein the vibration actuator operates to vibrate at least the mirror reflective element opposite to the determined vibration of the mirror reflective element.

7. The vehicular rearview mirror assembly of claim 6, wherein the vibration actuator operates to vibrate at least the mirror reflective element equal in magnitude and frequency with a 180 degree phase shift relative to the determined vibration of the mirror reflective element.

8. The vehicular rearview mirror assembly of claim 1, wherein the vibration sensor determines a vibration frequency of the mirror reflective element, and wherein the vibration actuator vibrates at least the mirror reflective element at the determined vibration frequency with a 180 degree phase shift.

9. The vehicular rearview mirror assembly of claim 1, wherein the vibration sensor determines vibration of the mirror reflective element relative to the mirror head, and wherein the vibration actuator vibrates the mirror reflective element relative to the mirror head.

10. The vehicular rearview mirror assembly of claim 1, wherein the vibration sensor determines vibration of the mirror reflective element and the mirror head relative to the vehicle, and wherein the vibration actuator vibrates the mirror reflective element and the mirror head relative to the vehicle.

11. The vehicular rearview mirror assembly of claim 1, wherein the vibration actuator is electrically operated based on the determined vibration of the mirror reflective element having an amplitude greater than a threshold amplitude, and wherein the vibration actuator vibrates at least the mirror reflective element so that the amplitude of the determined vibration is less than the threshold amplitude.

12. The vehicular rearview mirror assembly of claim 1, wherein the mirror head accommodates a printed circuit board (PCB), and wherein the PCB comprises a data processor for processing data captured by the vibration sensor.

13. A vehicular interior rearview mirror assembly, the vehicular interior rearview mirror assembly comprising:
a mirror head adjustable about a mounting structure, wherein the mounting structure is configured to mount the vehicular interior rearview mirror assembly at an interior portion of an interior cabin of a vehicle;
wherein the mirror head comprises a mirror reflective element;
wherein the mirror head accommodates a vibration sensor, and wherein, with the vehicular interior rearview mirror assembly mounted at the interior portion of the interior cabin of the vehicle, the vibration sensor is operable to determine vibration of the mirror reflective element and the mirror head relative to the interior portion of the interior cabin of the vehicle;
wherein the mirror head accommodates a vibration actuator, and wherein the vibration actuator is electrically operable to vibrate the mirror reflective element and the mirror head relative to the interior portion of the interior cabin of the vehicle; and
wherein, with the vehicular interior rearview mirror assembly mounted at the interior portion of the interior cabin of the vehicle, and based on the determined vibration of the mirror reflective element and the mirror head, the vibration actuator is electrically operated to vibrate the mirror reflective element and the mirror head to at least partially counter vibration of the mirror reflective element and the mirror head.

14. The vehicular interior rearview mirror assembly of claim 13, wherein the vibration actuator operates to vibrate the mirror reflective element and the mirror head opposite to the determined vibration of the mirror reflective element and the mirror head.

15. The vehicular interior rearview mirror assembly of claim 13, wherein the vibration sensor determines a vibration frequency of the mirror reflective element and the mirror head, and wherein the vibration actuator vibrates the mirror reflective element and the mirror head at the determined vibration frequency with a 180 degree phase shift.

16. The vehicular interior rearview mirror assembly of claim 13, wherein the vibration actuator is electrically operated based on the determined vibration of the mirror reflective element and the mirror head having an amplitude greater than a threshold amplitude, and wherein the vibration actuator vibrates the mirror reflective element and the mirror head so that the amplitude of the determined vibration is less than the threshold amplitude.

17. The vehicular rearview mirror assembly of claim 13, wherein the mirror head accommodates a printed circuit board (PCB), and wherein the PCB comprises a data processor for processing data captured by the vibration sensor.

18. A vehicular exterior rearview mirror assembly, the vehicular exterior rearview mirror assembly comprising:
a mirror head adjustable about a mounting structure, wherein the mounting structure is configured to mount the vehicular exterior rearview mirror assembly at an exterior portion of a vehicle;
wherein the mirror head comprises a mirror reflective element;
wherein the mirror head accommodates a vibration sensor, and wherein, with the vehicular exterior rearview mirror assembly mounted at the exterior portion of the vehicle, the vibration sensor is operable to determine vibration of the mirror reflective element relative to the mirror head;
wherein the mirror head accommodates a vibration actuator, and wherein the vibration actuator is electrically operable to vibrate the mirror reflective element relative to the mirror head; and
wherein, with the vehicular exterior rearview mirror assembly mounted at the exterior portion of the vehicle, and based on the determined vibration of the mirror reflective element, the vibration actuator is electrically operated to vibrate the mirror reflective element to at least partially counter vibration of the mirror reflective element.

19. The vehicular exterior rearview mirror assembly of claim 18, wherein the vibration actuator operates to vibrate the mirror reflective element opposite to the determined vibration of the mirror reflective element.

20. The vehicular exterior rearview mirror assembly of claim 18, wherein the vibration sensor determines a vibration frequency of the mirror reflective element, and wherein the vibration actuator vibrates the mirror reflective element at the determined vibration frequency with a 180 degree phase shift.

21. The vehicular exterior rearview mirror assembly of claim 18, wherein the vibration actuator is electrically operated based on the determined vibration of the mirror reflective element having an amplitude greater than a threshold amplitude, and wherein the vibration actuator vibrates the mirror reflective element so that the amplitude of the determined vibration is less than the threshold amplitude.
